(19) United States
(12) Patent Application Publication
(10) Pub. No.: US 2002/0042998 A1
(43) Pub. Date: Apr. 18, 2002

(54) Saw blade for making circular openings in construction materials

(76) Inventor: Mario Napoli, Toronto (CA)

Correspondence Address: David Rogers, Rogers Law Offices, Suite 1004, 357 Bay Street, Toronto, ON, M5H 2T7, CA

(21) Appl. No.: 09/956,919

(22) Filed: Sep. 21, 2001

(30) Foreign Application Priority Data
Sep. 22, 2000 (CA) 2,320,463

(51) Int. Cl. B27B 19/00; B26B 9/02

(52) U.S. Cl. 30/392; 30/277.4; 30/355; 30/356

(57) ABSTRACT

A saw blade, saw and method for making circular openings in construction materials. The saw is adapted to be attached to a handle, motor and holder assembly so that an up and down stroking motion can be provided to the saw blade. The saw blade is concave in cross-section along substantially its whole length, and the degree of curvature of the blade is the same throughout the length of the blade that is concave in cross-section. The degree of curvature is that necessary to make a circular opening of the size desired. To make the opening, a circle of the size of the opening desired is drawn on the construction material, a hole is drilled in the construction material inside and abutting the circle of a size slightly larger than that necessary to receive the blade, the blade is inserted in the hole, and the cutting edge of the blade is moved around the circle.

### FIELD OF THE INVENTION

This invention relates to a saw blade, a saw and a method for making circular openings in construction materials.

### BACKGROUND OF THE INVENTION

It is frequently necessary to make circular openings in construction materials such as construction metals, plaster containing wire mesh or plastic. Such openings are necessary, for example, where wires or cables are connected to switch boxes, or where plumbing pipes are connected to catch basins.

A drill known as a saucer drill is currently used to make circular openings in construction materials. The drill has a circular drill head in the shape of an inverted saucer with teeth around the rim. The drill provides a rotating motion to the drill head. While this is the best tool now available for making circular openings in construction materials, it has a number of drawbacks. The drill heads are very expensive and wear out quickly and it is very inconvenient for the drill operator to carry with him a number of drill heads on the job site.

A hand saw with a curved blade is shown in U.S. Pat. No. 2,421,137 to Miller. The Miller saw blade is concave in cross-section throughout a part of the length of the saw blade, but is curved either to the right or the left at the free end. The Miller blade is described as being used for making curved cuts in soft construction materials such as wood, but it could not be used for making circular openings of the type commonly desired in hard construction materials.

### SUMMARY OF THE INVENTION

According to this invention, a saw blade, saw and method is provided for making circular openings in construction materials.

According to the invention, a saw blade is provided that is adapted to be attached to a handle, motor and holder assembly capable of providing an up and down stroking motion to the blade.

The saw blade of the invention has an attachable end and a free end. The attachable end is adapted to be attached to a handle, motor and holder assembly, and is concave in cross section along substantially its whole length from the free end to a point near the attachable end. The degree of curvature is the same throughout the length of blade that is concave in cross section, and the degree of curvature is that necessary to make a circular opening of the size desired.

The saw of this invention has a handle, motor and holder assembly, adapted to provide an up and down stroking motion to the saw blade of this invention when the attachable end of the blade is attached to said assembly.

According to the method of this invention, the saw of this invention is used to make circular openings in construction materials by drawing a circle on the construction material of the size of the opening desired, drilling a hole in the construction material inside and abutting the circle of a size slightly greater than that necessary to receive the saw blade, inserting the saw blade into said opening, providing an up and down stroking motion to the blade, and moving the cutting edge of the blade completely around the circle to form the desired opening in the construction material.

### DESCRIPTION OF DRAWINGS

The preferred embodiments of the invention are described below with reference to the accompanying drawings, in which:

FIG. 1 is a side-view of the saw blade of this invention.

FIG. 2 is an enlarged cross sectional view taken along the line 2-2 of FIG. 1.

FIG. 3 is a side view of the saw of this invention with the blade attached to the holder, handle and motor assembly.

### DESCRIPTION OF PREFERRED EMBODIMENTS

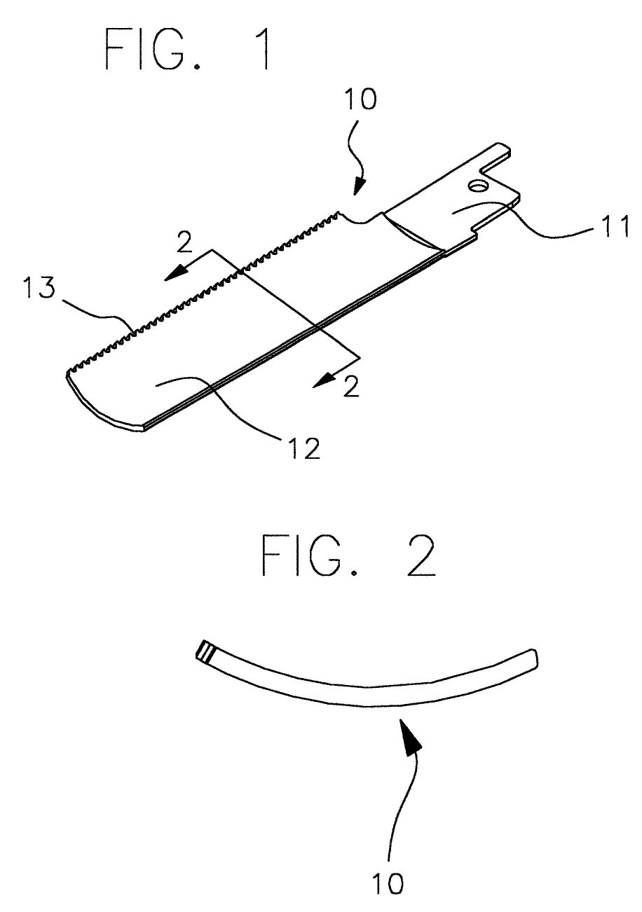

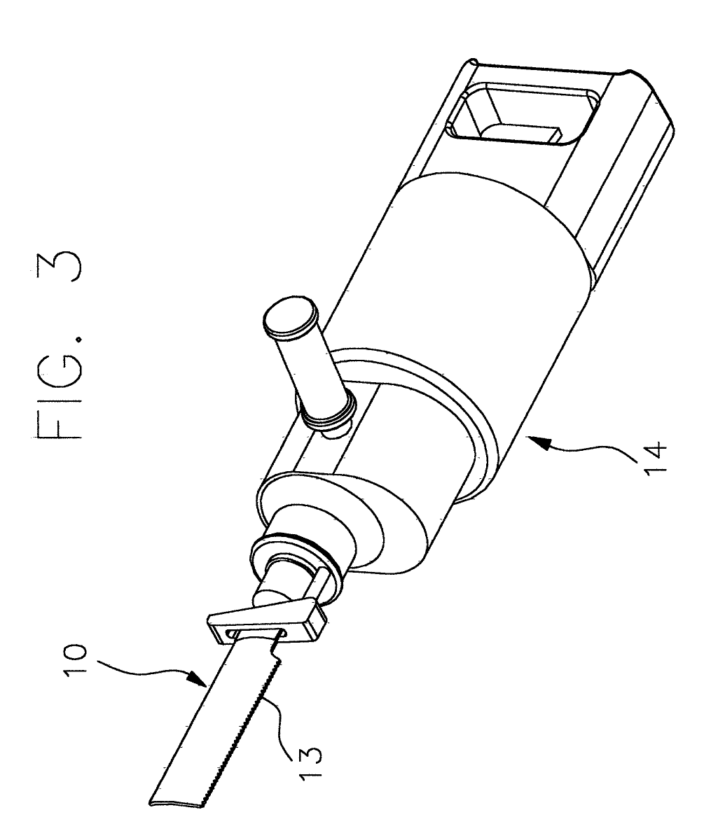

A preferred embodiment of the saw blade of this invention is generally indicated by reference numeral 10 in FIG. 1. The saw blade 10 has an attachable end 11, a free end 12 and a cutting edge 13. As seen in FIG. 2, the blade is concave in cross section, and the concave cross section extends from the free end 12 almost to the attachable end 11. The degree of curvature of the blade 10 is the same throughout the length of the blade that is concave in cross section, and the degree of curvature is that necessary to make a circular opening of the size desired. FIG. 3 shows the blade 10 attached to the handle, motor and holder assembly 14.

The width of the blade varies with the size of the opening to be made. The larger the diameter of the opening, the lower the angle of curvature, and if the blade is too narrow, it is difficult to follow the circumference of the opening to be made.

The distance across the outside surface of the length of the blade that is concave in cross section in a plane at right angles to the longitudinal axis of the blade is preferably at least ¼ inches. This distance depends upon the diameter of the opening to be made. If an opening from about 1 inch to about 12 inches in diameter is to be made, the said distance should be from about ¼ inches to about ¾ inches. To make an opening of a diameter from about 1 inch to about 4 inches, the said distance should preferably be from about ¼ inches to about ⅜ inches, and if an opening of about 1 inch in diameter is to be made, the said distance should preferably be about 5/16 inches.

The length of the blade is preferably from about 2 inches to about 6 inches, and more preferably about 4 inches.

The blade is preferably made of steel and most preferably of bimetal steel.

The blade may be used for making openings in construction material selected from the group consisting of construction metals, plaster containing wire mesh and plastic, and the construction metals are most commonly steel, copper or aluminum. The most common use of the invention is to make openings in a construction material consisting of steel of a thickness of from about 1/16 inches to about ⅛ inches and particularly steel of about 2 mm in thickness.

As seen in FIG. 3, the blade 10 is attached to a handle, motor and holder assembly 14 capable of providing an up and down stroking motion to the blade. Preferably the stroking motion should be from about 400 to about 3,200 strokes per minute or more preferably from 400 to 500 strokes per minute. The blade 10 may be detached from the assembly 14 and replaced by another blade of a different degree of curvature where it is desired to make an opening of a different size.

To make the opening in the construction material, a circle is drawn on the construction material, for example by using a template. A hole is drilled in the construction material inside and abutting the circle. The hole should be of a size slightly larger than that necessary to receive the blade so that there will be room to move the blade into position for making the opening. The blade 10 is then inserted in the hole and a stroking motion is provided to the blade 10 by the assembly 14 as the cutting edge 13 of the blade 10 moves completely around the circle to make the circular opening of the size desired.

I claim:

1. A saw blade for making circular openings in construction materials having an attachable end and a free end, the attachable end being adapted to be attached to a handle, motor and holder assembly so that an up and down stroking motion can be provided to the saw blade, the saw blade being concave in cross-section along substantially its whole length from said free end to a point near said attachable end, the degree of curvature of the blade being the same throughout the length of the blade that is concave in cross-section, and said degree of curvature being that necessary to make a circular opening of the size desired.

2. A saw blade as claimed in claim 1 for making circular openings of at least 1 inch in diameter, in which the distance across the outside surface of said length of the blade in a plane at right angles to the longitudinal axis of the blade is at least ¼ inches.

3. A saw blade as claimed in claim 2 for making circular openings of from about 1 inch to about 12 inches in diameter, in which said distance across the outside surface of said length of the blade is from about ¼ inches to about ¾ inches.

4. A saw blade as claimed in claim 2 for making circular openings of from about 1 inch to about 4 inches in diameter, in which said distance across the outside surface of said length of the blade is from about ¼ inches to about ⅜ inches.

5. A saw blade as claimed in claim 2 for making circular openings of about 1 inch in diameter, in which said distance across the outside surface of said length of the blade is about 5/16 inches.

6. A saw blade as claimed in claim 2, that is from about 2 inches to about 6 inches in length.

7. A saw blade as claimed in claim 5, that is about 4 inches in length.

8. A saw blade as claimed in claim 6, that is made of steel.

9. A saw blade as claimed in claim 8, that is made of bimetal steel.

10. A saw blade as claimed in claim 2, for making circular openings in a construction material selected from the group consisting of construction metals, plaster containing wire mesh and plastic.

11. A saw blade as claimed in claim 9, for making circular openings in a construction material selected from the group consisting of steel, copper and aluminum.

12. A saw blade as claimed in claim 10, for making circular openings in steel of from about 1/16 inch to about ⅛ inch in thickness.

13. A saw blade as claimed in claim 11, for making circular openings in steel of about 2 mm in thickness.

14. A saw for making circular openings in construction materials, comprising a handle, motor and holder assembly, and a saw blade having an attachable end and a free end, said attachable end being adapted to be attached to the assembly so that the assembly can provide an up and down stroking motion to the blade, the blade being concave in cross-section along substantially its whole length from said free end to a point near said attachable end, the degree of curvature being the same throughout said length of the blade that is concave in cross-section, and said degree of curvature being that necessary to make a circular opening of the size desired.

15. A saw as claimed in claim 14, in which the saw blade can be detached from the assembly and replaced with another saw blade of a different degree of curvature to make a circular opening of a different size.

16. A saw as claimed in claim 14, in which the assembly can provide an up and down stroking motion to the saw blade in the range of from about 400 to about 3,200 strokes per minute.

17. A saw as claimed in claim 15, in which the assembly can provide an up and down stroking motion to the saw blade in the range of from about 400 to about 500 strokes per minute.

18. A saw as claimed in claim 16 for making circular openings of at least 1 inch in diameter, in which the distance across the outside surface of said length of the blade in a plane at right angles to the longitudinal axis of the blade is at least ¼ inches.

19. A saw as claimed in claim 17 for making circular openings of from about 1 inch to about 4 inches in diameter, in which said distance across the outside surface of said length of the blade is from about ¼ inches to about ⅜ inches.

20. A saw as claimed in claim 18, in which said blade is from about 2 inches to about 6 inches in length.

21. A saw as claimed in claim 19, in which the saw blade is made of steel.

22. A method of making circular openings in construction materials with a saw, having a handle, motor, and holder assembly, the saw having a saw blade with an attachable end and a free end, said attachable end being attached to said assembly so that said assembly can provide an up and down stroking motion to said blade, said blade having a cutting edge and being concave in cross section along substantially its whole length from its free end to a point near said attachable end, the degree of curvature being the same throughout said length of the blade that is concave in cross section, and the degree of curvature being that necessary to make a circular opening of the size desired, in which a circle of the size of the opening desired is drawn on a construction material, a hole is drilled in the construction material inside and abutting said circle of a size slightly larger than that necessary to receive said blade, said blade is inserted in said hole, said blade is provided with an up and down stroking motion by said assembly, and the cutting edge of the said blade is moved around said circle to make the desired opening in said construction material.
